(19) United States
(12) Patent Application Publication
(10) Pub. No.: US 2008/0057944 A1
(43) Pub. Date: Mar. 6, 2008

(54) Method and apparatus for calling via selected networks

(75) Inventors: Srinivas Miriyala, Austin, TX (US); Sunil H. Madhani, Austin, TX (US); Farooq M. Butt, Austin, TX (US); Ronald G. Garriques, Lake Forest, IL (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Motorola, Inc., Schaumburg, IL (US)

(21) Appl. No.: 11/512,447

(22) Filed: Aug. 30, 2006

(51) Int. Cl. H04Q 7/20

(52) U.S. Cl. 455/425

(57) ABSTRACT

A device includes a wireless communication interface configured to couple to a plurality of networks, a processor coupled to the wireless communication interface, and a memory coupled to the processor. The memory is to store a set of executable instructions configured to manipulate the processor to determine a set of characteristics for each wireless network of a set of accessible wireless networks and determine a select wireless network of the set of accessible wireless networks based on a comparison of a set of characteristics of the device to the set of characteristics for each wireless network of the set of accessible wireless networks. The set of executable instructions further are configured to manipulate the processor to initiate a telephone call via the select wireless network.

### FIELD OF THE DISCLOSURE

The present disclosure relates generally to telephony-enabled networks and more particularly to establishing a telephone call in a multiple network environment.

### BACKGROUND

Telephonic technology has begun to find implementation in networks historically used for other purposes, such as in packetized data networks compliant with, for example, the Telecommunications Protocol/Internet Protocol (TCP) or the Asynchronous Transfer Mode (ATM) protocol. Thus, telephonic devices are being configured so as to interface with both conventional telephonic networks, such as cellular telephone networks, and non-conventional telephonic networks, such as wireless networks historically used to transfer non-voice data. Accordingly, such telephonic devices may be capable of establishing a telephone call via any of a number of these telephony-enabled networks types. When presented with the task of establishing an emergency telephone call, however, conventional telephonic devices generally are configured to use a preset network or preset network-type to establish the emergency telephone call. To illustrate, because conventional telephonic networks have long implemented emergency calling services, conventional telephonic devices typically are configured to conduct an emergency telephone call via a default conventional telephonic network. However, due to a variety of factors, the preset default network may not be the most advantageous network for establishing an emergency telephone call. Accordingly, an improved technique for establishing an emergency telephone call in an environment with multiple telephony-enabled networks would be advantageous.

### BRIEF DESCRIPTION OF THE DRAWINGS

The present disclosure may be better understood and its numerous features and advantages made apparent to those skilled in the art by referencing the accompanying drawings.

FIG. 1 is a block diagram illustrating an wireless calling environment in accordance with at least one embodiment of the present disclosure.

FIG. 2 is a block diagram illustrating an implementation of a wireless telephonic device in accordance with at least one embodiment of the present disclosure.

FIG. 3 is a diagram illustrating an state machine diagram for establishing an emergency telephone call in a multiple network environment in accordance with at least one embodiment of the present disclosure.

FIG. 4 is a flow diagram illustrating an method for determining one or more characteristics of a wireless network in accordance with at least one embodiment of the present disclosure.

FIG. 5 is a diagram illustrating a particular format of network characteristics as a table in accordance with at least one embodiment of the present disclosure.

FIG. 6 is a flow diagram illustrating a method for determining one or more characteristics of a wireless telephonic device in accordance with at least one embodiment of the present disclosure.

FIG. 7 is a diagram illustrating a particular format of telephonic device characteristics as a table in accordance with at least one embodiment of the present disclosure.

FIG. 8 is a flow diagram illustrating a method for determining a compatibility score for each of a plurality of networks in accordance with at least one embodiment of the present disclosure.

FIG. 9 is a diagram illustrating a scoring table for battery power and signal-to-noise characteristics in accordance with at least one embodiment of the present disclosure.

FIG. 10 is a diagram illustrating a scoring table for velocity characteristics in accordance with at least one embodiment of the present disclosure.

FIG. 11 is a diagram illustrating a scoring table for a plurality of networks in accordance with at least one embodiment of the present disclosure.

FIG. 12 is a diagram illustrating a rules-driven expert system for initiating an emergency telephone call via selected networks in accordance with at least one embodiment of the present disclosure.

The use of the same reference symbols in different drawings indicates similar or identical items.

### DETAILED DESCRIPTION

The following description is intended to convey a thorough understanding of the present disclosure by providing a number of specific embodiments and details involving establishing a telephone call in a multiple network environment. It is understood, however, that the present disclosure is not limited to these specific embodiments and details, which are exemplary only, and the scope of the disclosure is accordingly intended to be limited only by the following claims and equivalents thereof. It is further understood that one possessing ordinary skill in the art, in light of known systems and methods, would appreciate the use of the invention for its intended purposes and benefits in any number of alternative embodiments, depending upon specific design and other needs.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

It will be appreciated that the methods and the telephonic device described herein may include one or more conventional processors and unique stored program instructions that control the one or more processors, to implement, in conjunction with certain non-processor circuits, some of the functions of the electronic device described herein. The non-processor circuits may include, but are not limited to, a radio receiver, a radio transmitter, signal drivers, clock circuits, power source circuits, and user input devices.

In this document, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

In accordance with one aspect of the present disclosure, a method includes determining a set of characteristics for each wireless network of a plurality of wireless networks accessible by a wireless telephonic device. The method further includes determining a select wireless network of the plurality of wireless networks based on a comparison of a set of characteristics of the wireless telephonic device to the set of characteristics of each wireless network of the plurality of wireless networks. The method additionally includes initiating, at the wireless telephonic device, a telephone call via the select wireless network.

In accordance with another aspect of the present disclosure, a method includes receiving user input indicating an emergency telephone call is to be made at a wireless telephonic device. The method further includes determining a first network of a plurality of wireless networks available to the wireless telephonic device and determining a second network of the plurality of wireless networks, the second network of a different network type than the first network. The method additionally includes initiating a first emergency telephone call from the wireless telephonic device via each of the first network and the second network, and disconnecting the second one of the first network or the second network to establish the emergency telephone call.

In accordance with another aspect of the present disclosure, a device includes a wireless communication interface configured to couple to a plurality of networks, a processor coupled to the wireless communication interface, and a memory coupled to the processor. The memory is to store a set of executable instructions configured to manipulate the processor to determine a set of characteristics for each wireless network of a set of accessible wireless networks and determine a select wireless network of the set of accessible wireless networks based on a comparison of a set of characteristics of the device to the set of characteristics for each wireless network of the set of accessible wireless networks. The set of executable instructions further are configured to manipulate the processor to initiate a telephone call via the select wireless network.

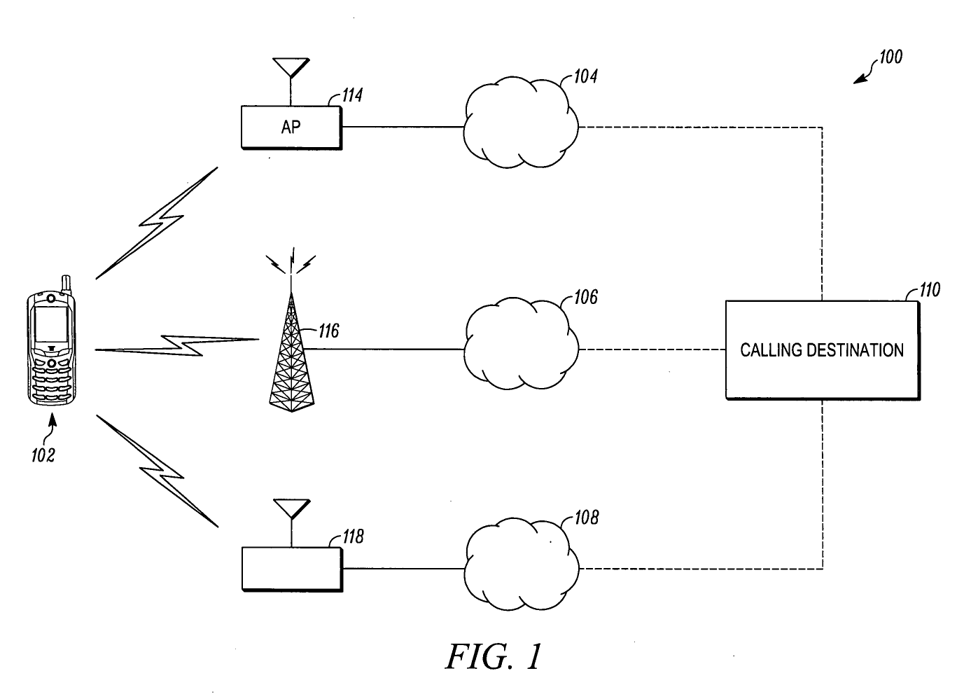

FIGS. 1-12 illustrate techniques for establishing a telephone call at a wireless telephonic device in an environment with multiple telephony-enabled networks available to the wireless telephonic device. In one embodiment, the wireless telephonic device identifies a plurality of telephony-enabled networks accessible by the wireless telephonic device. The wireless telephonic device determines a set of one characteristics for each identified network related to the corresponding network's operation in relation to the wireless telephonic device. The wireless telephonic device also determines a set of characteristics related to its own operation. Periodically, or in the event that the wireless telephonic device detects that the user potentially is initiating an emergency telephone call, the wireless telephonic device compares its operational set of characteristics with the characteristics of each identified network to identify the relative compatibility of each network with the wireless telephonic device's characteristics for the purposes of establishing an emergency telephone call. In the event that an emergency telephone call is being made by the user, the wireless telephonic device identifies a network as the primary network based on the relative compatibilities of the networks, activates its interface associated with the primary network, and initiates the emergency telephone call via the primary network. Further, the wireless telephonic device can identify one or more secondary networks based on their relative compatibilities and initiate the emergency telephone call via the one or more secondary networks in parallel with the initiation of the emergency telephone call via the primary network. The wireless telephonic device can continue the first emergency telephone call when it is connected and terminate the other emergency telephone call attempts. Further, in the event that an emergency telephone call is unexpectedly terminated, the wireless telephonic device can attempt to reestablish the emergency telephone call via the same network or an alternate network, which can be selected based on relative compatibility.

For ease of discussion, techniques of the present disclosure are described in the exemplary context of emergency telephone calls. However, it will be appreciated that these techniques are not limited to emergency telephone calling and may be adapted for other types of telephone calling without departing from the scope of the present disclosure. The term “emergency telephone call,” as used herein, refers to a telephone call that has been designated as high-priority such that its timely and/or reliable connection is of particular importance. An emergency telephone call may be designated as such based on a public or official designation (such as the emergency “911” system). Alternately, an emergency telephone call may be explicitly or implicitly designated as such by the user of a wireless telephonic device or a third party. To illustrate, a child's portable phone may have a button programmed to call home and the home telephone number, when called via the child's portable phone, therefore may be designated as an emergency telephone call. The term “telephone number,” as used herein, refers to a sequence of numbers or other reference associated with a calling destination. Examples of telephone numbers can include, but are not limited to, a conventional telephone number (e.g., XXX-XXX-XXXX), an internet protocol address (e.g., XXX.XXX.XXX) or other data network address, and the like. Accordingly, the term “emergency telephone number,” as used herein, refers to a telephone number that is associated with the calling destination of an emergency telephone call. From the previous examples, the emergency telephone number “911” or the home telephone of the child's parents each would be considered emergency telephone numbers in their respective contexts.

FIG. 1 illustrates a wireless calling environment 100 in accordance with at least one embodiment of the present disclosure. The wireless network environment 100 includes a wireless telephonic device 102 and a plurality of telephony-enabled wireless networks, including wireless networks 104, 106, and 108, which may be capable of facilitating voice communications with an emergency calling destination 110, such as a PSAP. Although FIG. 1 illustrates a single emergency calling destination 110, it will be appreciated that in certain instances some or all of the wireless networks each may be associated with different emergency calling destinations 110. The wireless telephonic device 102, in one embodiment, includes a portable battery-powered device, such as, for example, a cellular phone, a voice-enabled personal digital assistant, a notebook computer, and the like.

In the illustrated example, the wireless network 104 includes a metropolitan area network (MAN) or a local area network (LAN), the wireless network 106 includes a wide area network (WAN), and the wireless network 108 includes a personal area network (PAN). A WAN includes any of a variety of wireless networks having a wide coverage area, such as conventional cellular networks including, for example, code division multiple access (CDMA)-based networks, global system for mobile communication (GSM)-based networks, time division multiple access (TDMA)-based networks, universal mobile telecommunications system (UMTS)-based networks, and the like. A MAN includes any of a variety of wireless networks having a coverage area on a metropolitan scale, such a wireless network based on an Institute of Electrical and Electronics Engineers (IEEE) 802.16 standard (also referred to as “WiMax”). A LAN includes any of a variety of wireless having a local scale, such as a wireless network based on an IEEE 802.11 standard (also referred to as “WiFi”). A PAN includes any of a variety of wireless networks having a coverage area on a personal scale, such as a wireless network based on an IEEE 802.15 standard or a wireless network based on a Bluetooth™ standard, or an infrared network based on an Infra Red Data Association (IRDA) standard.

The wireless telephonic device 102, in one embodiment, includes a wireless communication device that enables it to establish wireless communications channels with wireless networks within its communication range. To illustrate, the wireless telephonic device 102 may include an IEEE 802.xx-based (e.g., IEEE 802.16) transceiver to communicate with the wireless network 104 via an access point 114, a cellular transceiver (e.g., a CDMA or GSM transceiver) to communicate with the wireless network 106 via a base transceiver system (BTS) tower 116, and a Bluetooth-based transceiver to communicate with the wireless network 108 via a Bluetooth-enabled transceiver 118 associated with the wireless network 108.

During non-emergency voice operation, the wireless telephonic device 102 typically is configured to establish a communication channel with a calling destination via a default or preferred network. To illustrate, the wireless telephonic device 102 may be configured to primarily conduct voice communications between a user and a calling destination using a Voice over IP (VoIP)-based standard and therefore typically uses a WAN or LAN network, such as the wireless network 104, to communicate voice data between the wireless telephonic device 102 and the calling destination via an IP-based network. Alternately, the wireless telephonic device 102 may be associated with a cellular provider and therefore may be configured to primarily conduct non-emergency voice communications via a conventional cellular network associated with the cellular provider, such as via the wireless network 106.

Due to their high-priority nature, emergency telephone calls generally benefit from a rapidly-established and reliable connection with the emergency calling destination 110. However, of the networks accessible to the wireless telephonic device 102 at the time of the call, the default network for the wireless telephonic device 102 may not be the network that is most compatible with these requirements. Accordingly, in one embodiment, the wireless telephonic device 102 is configured to assess multiple accessible networks to determine one or more networks via which an emergency telephone call is to be initiated based on their compatibility with characteristics of the wireless telephonic device 102 with the intent to achieve a rapidly-connected and/or reliable emergency telephone call connection with the emergency calling destination 110.

This assessment process, in one embodiment, includes determining the characteristics of the wireless telephonic device 102 and the characteristics of the available wireless networks that are related to, or have some bearing on, the ability to establish an emergency telephone call in a rapid or reliable manner, and then determining the one or more wireless networks that are most compatible with the characteristics of the wireless telephonic device 102 for establishing an emergency telephone call. The characteristics of the wireless telephonic device 102 can include, for example, the remaining battery life of the wireless telephonic device 102, the power consumption of each network interface, the location capabilities of the wireless telephonic device 102 (e.g., whether the wireless telephonic device 102 has global positioning system (GPS) or assisted GPS capabilities), the velocity (instant or average) of the wireless telephonic device 102, and the like. The characteristics of a wireless network can include, for example, the signal-to-noise (SNR) ratio of its signal with respect to the wireless telephonic device 102, its ability to handle certain velocities of the wireless telephonic device 102 as determined based on its coverage area and hand-off capabilities, its accessibility to the wireless telephonic device 102, its capability of connecting to an emergency telephone calling destination, its capability and accuracy in determining the location of the wireless telephonic device and the like.

To illustrate by way of example, assume that the wireless telephonic device 102 is stationary and has little battery power remaining and further assume that it takes considerably less power for the wireless telephonic device 102 to communicate via the wireless network 108 (a PAN) than the wireless network 104 (a MAN or LAN) or the wireless network 106 (a WAN). All else being equal and assuming the emergency telephone emergency calling destination 110 can be reached via the wireless network 108, the wireless network 108 may be most compatible network with the characteristics of the wireless telephonic device 102 due to the low consumption of power required to communicate with it. In contrast, assume that the wireless telephonic device 102 is moving at a high velocity and the wireless network 108 has a relatively limited coverage area, so the wireless network 108 may be less compatible with the characteristics of the wireless telephonic device 102 because the wireless telephonic device 102 potentially could leave the range of the wireless network 108 during an emergency telephone call, thereby disrupting the emergency telephone call. Accordingly, in this instance the wireless telephonic device 102 may determine that one of the wireless network 104 or the wireless network 106 is more compatible with its characteristics for the purposes of establishing and conducting an emergency telephone call.

As discussed in greater detail herein, any of a variety of techniques can be utilized to compare the characteristics of the available wireless networks with the characteristics of the wireless telephonic device so as to identify one or more wireless networks via which an emergency telephone call is to be initiated. These techniques can include, but are not limited to, a scoring technique based on predetermined scores for various characteristic combinations, an expert system-based rule technique, a fuzzy logic-based technique, or combinations thereof.

Upon identification of one or more select networks and in response to user input indicating an emergency telephone call is to be initiated, the wireless telephonic device 102 initiates the emergency telephone call via a primary network of the one or more select networks. For redundancy purposes, the wireless telephonic device 102 can initiate the emergency telephone call over one or more secondary networks of the one or more select networks in parallel with the emergency telephone call over the primary network. After the emergency telephone call is determined to be established over one of the networks, the emergency telephone call(s) over the other networks can be terminated. In the event that the emergency telephone call is subsequently disrupted, the wireless telephonic device 102 can reinitiate the emergency telephone call via the same network or an alternate network.

By selecting and initiating an emergency telephone call on one or more networks based on the networks' compatibilities with the characteristics of the wireless telephonic device 102 rather than using a default network for emergency telephone calling, a more rapidly established or more reliable emergency telephone call may be achieved. To illustrate, the default network for voice communications may have relatively poor velocity characteristics due to a limited coverage area or an inefficient hand-off protocol, whereas other accessible networks may be well suited for handling high-velocity telephonic devices. Thus, if a wireless telephonic device moving at a high velocity were to use only the default network for an emergency telephone call, it would have a high likelihood of experiencing an unintended termination of the emergency telephone call as the telephonic device moves out of range of the default network. Conversely, if configured to select an alternate network that has sufficient velocity characteristics as its primary network, a telephonic device moving at a high velocity would be less likely to experience an unintended termination of an emergency telephone call conducted via the alternate primary network.

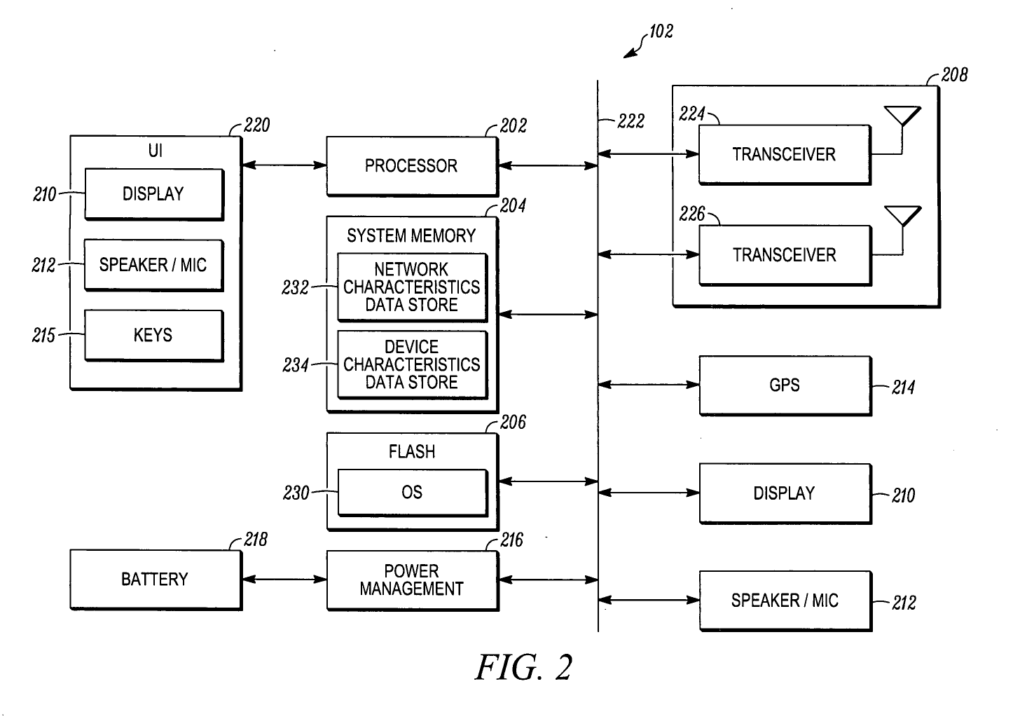

FIG. 2 illustrates an implementation of the wireless telephonic device 102 in accordance with at least one embodiment of the present disclosure. In the depicted example, the wireless telephonic device 102 includes a processor 202 (e.g., a central processing device or CPU), one or more memories, such as system memory 204 and flash memory 206, a wireless communication interface 208, a display device 210, a speaker/microphone device 212, a location or GPS device 214, a power management device 216, a battery 218, and a user interface (UI) 220 connected via one or more busses 222 or other interconnects.

The wireless communication interface 208 includes a plurality of transceivers, such as transceivers 224 and 226, each configured to establish a wireless connection with a corresponding network type. To illustrate, the transceiver 224 can be compatible with the IEEE 802.xx standards (e.g., IEEE 802.11, 802.15, and 802.16, etc.) and therefore capable of communicating with a LAN, a MAN, or a PAN, whereas the transceiver 226 can be compatible with a conventional cellular standard and therefore capable of communicating with a WAN. In one embodiment, the transceivers of the wireless communication interface 208 are configured to determine their respective SNRs for their wireless connections and provide this SNR information to the processor 202 for processing.

The user interface 220 is shown including a display device 210 and a speaker/microphone device 212. Additional or substitute user interface components can be included, such as a touchscreen or keys 213. The display device 210 includes a display and a display controller for processing image data received from the processor 202. The speaker/microphone device 212 includes a digital-to-analog converter (DAC) and a speaker for outputting audio information from the processor 202 and a microphone and an analog-to-digital converter (ADC) for providing audio information to the processor 202. The user interface 220 includes keys, buttons, switches, and other user-manipulated input devices (e.g., a keypad) to receive input from a user for processing at the processor 202.

The location or GPS device 214 includes a GPS antenna system or other location determination device for determining a location of the wireless telephonic device 102 and providing a representation of the location to the processor 202. The processor 202, in turn, can use the location information to determine a velocity of the wireless telephonic device 102. To illustrate, given two location points of the wireless telephonic device 102, the processor 202 can determine the velocity based on the time spent traversing the distance between the two location points. In embodiments where GPS is not enabled at the wireless telephonic device 102, alternate techniques for determining the velocity, or an approximation thereof, can be implemented. One technique includes determining the number of access point associations/disassociations or cellular hand-offs that occur in a given time period and based on the number of hand-offs and the average coverage area of the access points or cells, the approximate velocity can be determined.

The power management device 216 monitors the battery 218 and provides an indication of the remaining battery power available to the processor 202. The indication may represent, for example, a percentage or proportion of battery life remaining, an approximation of the time remaining until the battery is drained at the current power consumption rate, and the like.

The processor 202 executes a set of instructions stored at a computer readable medium, such as the flash memory 206, whereby the set of instructions represent an operating system (OS 230) or other software application. The OS 230 manipulates the processor 202 to initiate and conduct telephone calls, provide visual information via the display device 210, respond to user input via the user interface 220, and the like. Further, in one embodiment, the OS 230 manipulates the processor 202 to perform the network identification and selection processes described herein. In an alternate embodiment, some or all of the exemplary techniques described herein are implemented, in whole or in part, as hardware components of the wireless telephonic device 102.

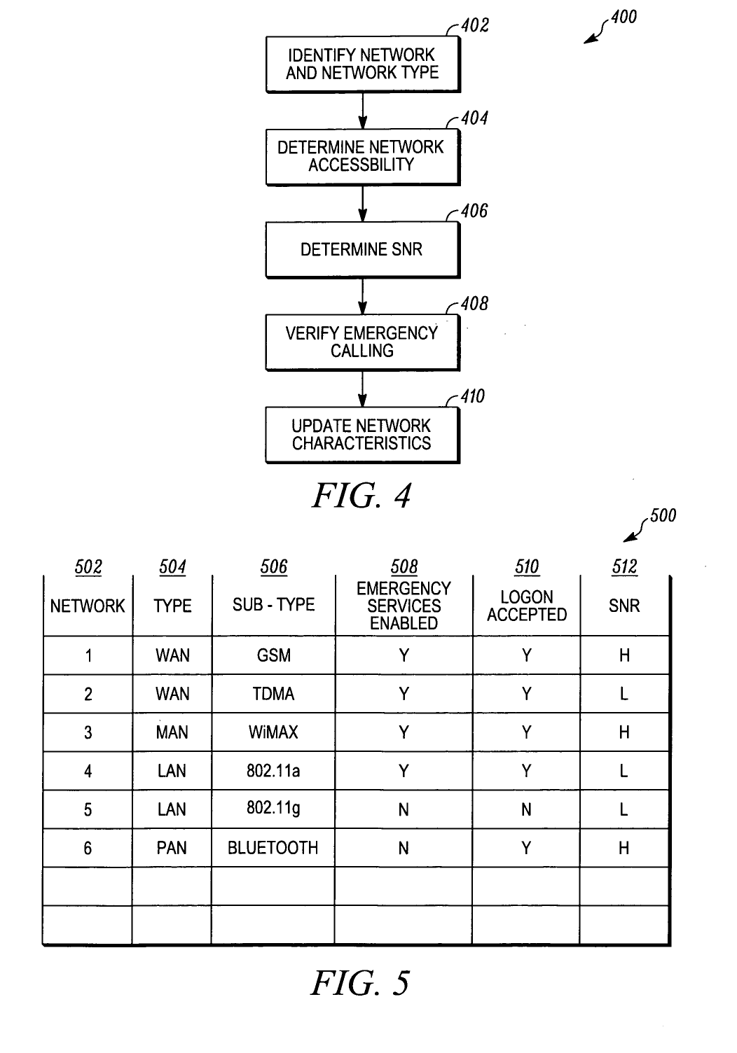

In one embodiment, the OS 230 is configured to manipulate the processor 202 to compile or otherwise determine a set of characteristics (i.e., one or more characteristics) of each of the wireless networks accessible via the wireless communication interface 208 that relate to each wireless network's ability to conduct an emergency telephone call and to store representations of the sets of characteristics in a network characteristics data store 232 (e.g., a table or database) at, for example, the system memory 204. These characteristics can include, for example, the ability of each wireless network to handle various velocities of the wireless telephonic device 102 (i.e., their velocity characteristics), the SNR of the signal of each wireless network, the power consumed by a wireless transceiver of the wireless communication device 208 in communicating with a corresponding wireless network, and the like. A method for determining these characteristics is described herein with reference to FIG. 4 and an implementation of the network characteristics data store 232 is described herein with reference to FIG. 5.

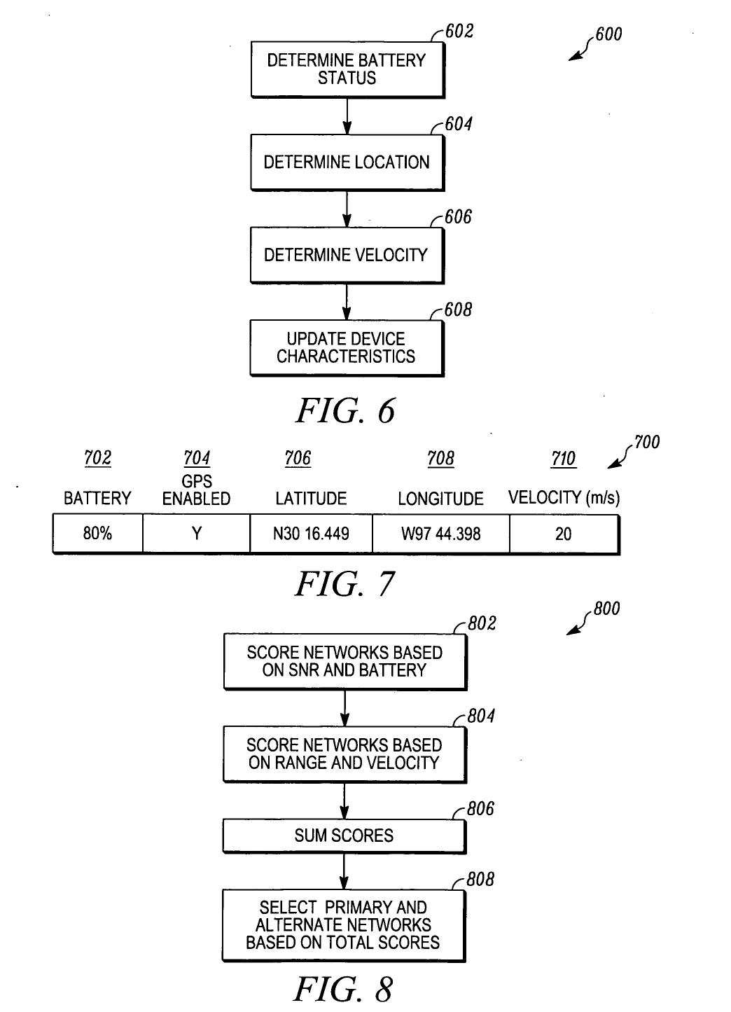

The OS 230 also is configured to manipulate the processor 202 to compile or otherwise determine a set of characteristics (i.e., one or more characteristics) of the wireless telephonic device 102 that relate to the ability of the wireless telephonic device 102 to conduct an emergency telephone call, and store representations of the set of characteristics in a device characteristics data store 234. These characteristics can include, for example, the velocity of the wireless telephonic device 102, the remaining battery power determined from information provided by the power management device 216, and the like. An method for determining these characteristics is described herein with reference to FIG. 6 and an implementation of the device characteristics data store 234 is described herein with reference to FIG. 7.

On a periodic basis, or in response to detecting a user's entry of a potential emergency telephone number, the OS 230 manipulates the processor 202 to compare the characteristics of the available wireless networks to the characteristics of the wireless telephonic device 102 to determine the relative compatibility of each available wireless network to the wireless telephonic device 102 for the purpose of conducting an emergency telephone call. Based on these relative compatibilities, the OS 230 manipulates the processor 202 to determine one or more select wireless networks from the plurality of accessible wireless networks. In the event that an emergency telephone number is entered by the user, the OS 230 then manipulates the processor 202 to initiate the emergency telephone call over one or more of the select wireless networks. The wireless telephonic device 102 then can continue a connection of the first emergency telephone call to connect (e.g., the first to receive a ringing tone or to confirm a human voice at the calling destination) and the other initiated emergency telephone calls can be terminated.

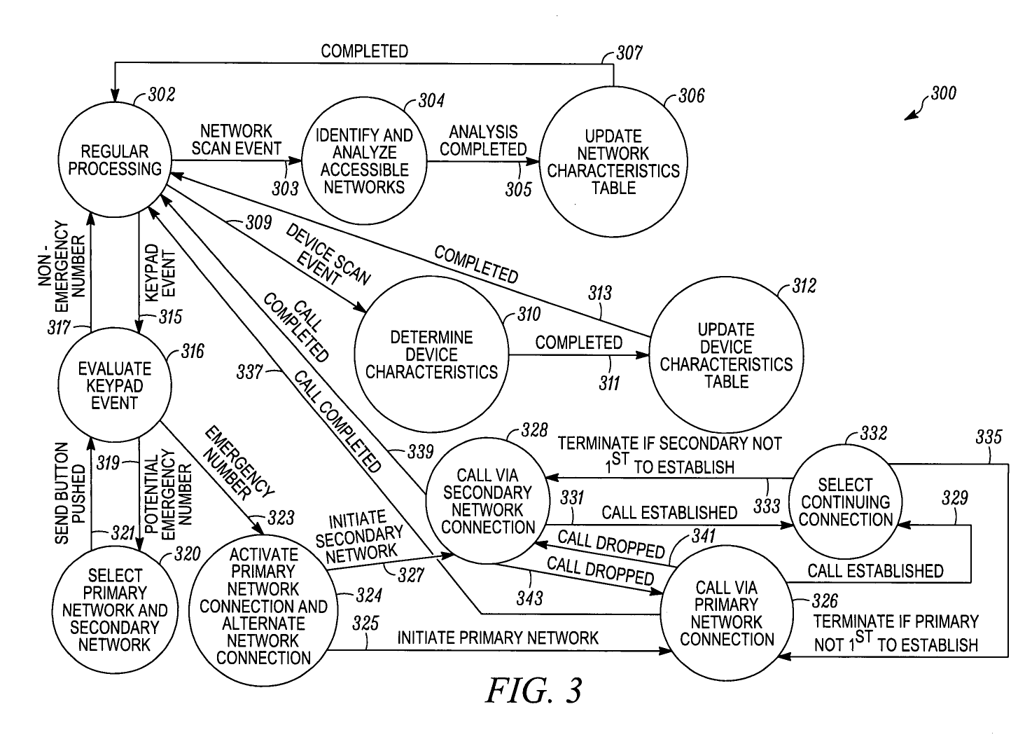

FIG. 3 illustrates a state machine diagram 300 implemented by the OS 230 of the wireless telephonic device 102 of FIG. 2 in accordance with at least one embodiment of the present disclosure. Upon initialization, the wireless telephonic device 102 enters state 302, which represents a regular processing state whereby the wireless telephonic device 102 operates in a conventional manner with respect to non-emergency telephone calls and idle operation.

In response to a network scan event 303 (e.g., the expiration of a timer or the entry of a potential emergency telephone number via the user interface), the state machine 300 enters state 304 whereby networks accessible to the wireless telephonic device 102 are identified and the identified networks are analyzed to determine their sets of characteristics. A method for determining the characteristics of the accessible networks is described herein with respect to FIG. 4. After the analysis of the accessible networks is completed (event 305), the state machine diagram 300 enters state 306, whereby the network characteristics data store 232 (FIG. 2) is updated based on the characteristics information obtained at state 304. Upon completion of the update (event 307), the state machine diagram 300 returns to state 302.

In response to a device scan event 309 (e.g., the expiration of a timer or the entry of a potential emergency telephone number), the state machine 300 enters state 310 whereby the set of characteristics of the wireless telephonic device 102 related to the ability to conduct an emergency telephone call is determined. An method for determining the characteristics of the wireless telephonic device 102 is described herein with respect to FIG. 6. After the analysis of the wireless telephonic device 102 is completed (event 311), the state machine diagram 300 enters state 312, whereby the device characteristics data store 234 (FIG. 2) is updated based on the characteristics information obtained at state 310. Upon completion of the update (event 313), the state machine 300 returns to state 302.

In response to a keypad event 315 (e.g., the manipulation of a key or switch by the user), the wireless telephonic device 102 enters state 316, whereby the wireless telephonic device 102 evaluates the keypad event 315 to determine if a potential emergency telephone number has been entered. To illustrate, the wireless telephonic device 102 can store a list of emergency telephone numbers (predetermined, user-defined, or both) and determine whether an entered number or sequence of numbers matches a corresponding initial numbering sequence of any number in the list. For example, assume that the emergency telephone number “911” is listed. The initial input of the number 9 via the “9” key on a key pad therefore would be identified as a potential emergency telephone number due to its match with an initial numbering of the “911” emergency telephone number. As another example, assume that the list does not contain any emergency telephone numbers that start with the number sequence “800.” The initial input of the number sequence “800” via the key pad therefore would be identified as a non-emergency telephone number because it does not match an initial numbering of any of the listed emergency telephone numbers.

If the key pad event 315 is evaluated at state 316 as indicating a non-emergency telephone number (event 317), processing returns to state 302. If the keypad event 315 is evaluated as a potential emergency telephone number (event 319), the state machine 300 enters state 320. At state 320, the wireless telephonic device 102 selects or otherwise determines a primary network and optionally one or more secondary networks from the plurality of accessible networks based on a comparison of the characteristics of the networks as represented by the network characteristics data store 232 (FIG. 2) with the characteristics of the wireless telephonic device 102 as represented by the device characteristics data store 234 (FIG. 2), whereby the results of the comparison indicate the relative potential compatibility of each accessible network. In one embodiment, the primary network is selected as the network indicated as most compatible and one or more secondary networks are selected as the networks indicated to have the highest compatibility of the remaining networks. For ease of discussion, an instance whereby one secondary network is selected is described herein. A method for selecting or otherwise determining the primary network and the secondary network is described herein with reference to FIGS. 8-11.

In response to an event 321 indicating that the user desires to initiate a telephone call (such as by pressing a “send” button on a keypad or by entering a sufficiently long number sequence), the state machine 300 returns to state 316, where the entered number sequence is evaluated to determine whether it is an actual emergency telephone number. In the event that an initial sequence of numbers identified as a potential emergency telephone number is subsequently identified as a non-emergency telephone number after a more complete number sequence is entered (event 317), the state machine returns to state 302. In the event that the complete number sequence matches a complete emergency telephone number, the entered telephone number is identified as an emergency telephone number (event 323) and the state machine 300 enters state 324.

At state 324, the wireless telephonic device 102 configures the wireless communications device 208 (FIG. 2) so as to activate interfaces with the primary and secondary networks, if not already activated. The configuration can include, for example, loading protocol stacks for the network types of the primary and secondary networks, powering the transceiver circuitry used to communicate with the primary and secondary, performing initial network association (e.g., base station hand shaking), registration, authentication, and the like. In one embodiment, the activation of the interface for the primary network and the activation of the interface to the second network occur concurrently so as to reduce the total activation time.

After the interface to the primary network is activated (event 325), the state machine 300 enters state 326, whereby the wireless telephonic device 102 initiates the emergency telephone call via the interface to the primary network. Likewise, after the interface to the secondary network is activated (event 327), the state machine 300 enters state 328, whereby the wireless telephonic device 102 initiates the emergency telephone call via the interface to the secondary network. In at least one embodiment, the state machine 300 can operate in both state 326 and state 328 concurrently such that the emergency telephone call is initiated concurrently via both the primary network and the secondary network. As described above, there can be more than one secondary network, and the state machine can accommodate multiple states 328 in that circumstance.

The initiation of an emergency telephone call typically depends on the network type. To illustrate, in an IP-based network, the initiation of an emergency telephone call can include, for example, establishing a VoIP connection between the wireless telephonic device 102 and a destination device at the IP address or conventional telephone number identified as the emergency telephone number. Alternately, in a conventional cellular network, the initiation of an emergency telephone call can include, for example, submission of the emergency telephone number to the cellular network so that a connection may be switched on between the wireless telephonic device 102 and the calling destination via the various central offices and local offices in the associated telephone network.

After the wireless telephonic device 102 determines that the emergency telephone call has been established via the primary network (event 329) or determines that the emergency telephone call has been established via the secondary network (event 331), the state machine 300 enters state 332. In one embodiment, an emergency telephone call is determined to be established upon the occurrence of a predetermined event, such as the presence of a ringing tone, the presence of a human voice, or a signal from the calling destination that a telephone connection has been established. At state 332, the wireless telephonic device 102 determines which of the emergency telephone calls to continue and which of the emergency telephone calls to terminate. In one embodiment, the wireless telephonic device 102 selects the first emergency telephone call to establish a connection. Thus, if event 329 occurs first, the emergency telephone call on the secondary network is terminated (event 333) and the state machine 300 returns to state 326 to continue conducting the emergency telephone call via the primary network. Conversely, if event 331 occurs first, the emergency telephone call on the primary network is terminated (event 335) and the state machine 300 returns to state 328 to continue conducting the emergency telephone call via the secondary network.

It will be appreciated that other techniques may be used to select between established emergency telephone calls for continuance and termination as appropriate. To illustrate, a weighted scheme may be applied whereby the relative compatibility of each network and the time needed to establish the emergency telephone call for each network is used to select a network for continuing the emergency telephone call.

Upon proper completion of the emergency telephone call (event 337 or event 339), the state machine 300 returns to state 302 for regular processing. However, should the continued emergency telephone call be unexpectedly terminated, such as by a loss of connection with the network, the portable telephone device 102, in one embodiment, attempts to reestablish the emergency telephone call via an alternate network. To illustrate, if the emergency telephone call is continued on the primary network and then is unexpectedly terminated (event 341), the state machine 300 enters state 328, whereby the emergency telephone call is reinitiated via the secondary network. Likewise, if the emergency telephone call is continued on the secondary network and then is unexpectedly terminated (event 343), the state machine 300 enters state 339, whereby the emergency telephone call is reinitiated via the primary network.

FIG. 4 illustrates a method 400 for determining one or more characteristics of a wireless network as they relate to the ability of the network to conduct an emergency telephone call in accordance with at least one embodiment of the present disclosure. At block 402, a wireless telephonic device (e.g., the wireless telephonic device 102, FIG. 1) identifies networks in range and determines their network type. The identification of in range networks and their type can include, for example, analysis of beacon signals (such as base station identification (BSID) broadcast packets). However, in certain instances, while the wireless telephonic device may be able to associate with an access point associated with a wireless network, the wireless network may be inaccessible due to password protection, filtering protection, and the like. Accordingly, at block 404 the wireless telephonic device 102 determines a set of accessible networks from the identified wireless networks based on whether they have implemented passwords or other access-denial techniques.

At block 406, the wireless telephonic device determines the signal-to-noise ratio (SNR) of the signal or signals transmitted by each network of the set of accessible networks. The SNR may be represented by an average SNR or an instantaneous SNR. In one embodiment, the physical layer (PHY) of the wireless transceiver(s) associated with each network type determines the SNR on a periodic basis or in response to a predetermined event.

Although most conventional cellular networks are configured to provide emergency telephone calling services, such as location detection (either via GPS at the mobile device or by triangulation) and a call back number to a local PSAP due to governmental mandate, other telephony-enabled wireless networks that only recently have begun to be used for wide-scale telephony services, such as MANs and LANs, may not provide emergency telephone calling services for telephony communications. Accordingly, at block 408, the wireless telephonic device determines whether each network of the set of accessible networks is enabled to provide emergency telephone calling services. The wireless telephonic device can determine whether an accessible wireless network provides emergency telephone calling services by analyzing a field of a packet broadcast by the wireless network that indicates whether is provides emergency telephone calling services, by consulting a predetermined list of wireless networks that provide emergency telephone calling services, or alternately, do not provide emergency telephone calling services, and the like.

At block 410, the wireless telephonic device updates the set of characteristics associated with each accessible network with the characteristics information determined at blocks 402-408. To illustrate, the wireless telephonic device can update or overwrite various fields in the network characteristics data store 232 (FIG. 2) so as to update the characteristics information for the set of accessible networks.

FIG. 5 illustrates an example format of the network characteristics data store 232 as a table 500 in accordance with at least one embodiment of the present disclosure. As depicted, the table 500 includes a plurality of entries, each entry corresponding to a wireless network and including a network ID field 502 used to index the entry, a general network type field 504 to identify the general network type (such as a WAN, a MAN, a LAN, a PAN, etc.), a network sub-type field 506 to identify a particular network standard for the corresponding network, an emergency services field 508 to indicate whether the corresponding network supports emergency telephone calling services, an accessibility field 510 indicating whether the wireless telephonic device 102 is able to logon to or otherwise access the corresponding network and a SNR field 512 indicating the SNR of the signal or signals transmitted by the corresponding wireless network. In the illustrated embodiment, the SNR of a corresponding network is represented in a relative form, such as “High” or “H” and “Low” or “L.” A more fine-grained representation, such as the representation of the SNR from, for example, the set including “low,” “medium-low,” “medium,” “medium-high,” and “high” representations also could be used. The thresholds between the various relative values of the set can be set by the user, set by a manufacturer or other provider of the wireless telephonic device 102, and the like. Alternately, the actual SNR value (e.g. 5 decibels (dB)) can be represented by the SNR field 512.

FIG. 6 illustrates an method 600 for determining one or more characteristics for a wireless telephonic device (e.g., the wireless telephonic device 102, FIG. 2) as they relate to the ability of the wireless telephonic device to conduct an emergency telephone call in accordance with at least one embodiment of the present disclosure. At block 602, the wireless telephonic device determines the status of its power source (typically a battery) to determine the remaining power available. As discussed above, the remaining power available may be represented as a relative capacity remaining (e.g., 30% power remaining or “low remaining power”) or as an estimate of a remaining time of operation afforded by the power source at the current power consumption rate.

At block 604, the wireless telephonic device determines its location in the event that it implements a GPS system or other location detection system. At block 606, the wireless telephonic device determines its velocity. In one embodiment, the velocity is determined based on one or more locations of the wireless telephonic device detected at block 604 and the time lapse between when the locations were determined. In another embodiment, the velocity of wireless telephonic device is determined based on the rate of access point associations/disassociations or handoffs in view of the average coverage area of the access points. The determined velocity may be a current instantaneous velocity or it may be an average velocity over a predefined time window.

At block 608, the wireless telephonic device updates its set of characteristics with the characteristics information determined at blocks 602-606. To illustrate, the wireless telephonic device can update or overwrite various fields in the device characteristics data store 234 (FIG. 2) so as to update the characteristics information for the wireless telephonic device.

FIG. 7 illustrates an example format of the device characteristics data store 234 (FIG. 2) as a table 700 in accordance with at least one embodiment of the present disclosure. In the depicted example, the table 700 includes a plurality of fields, such as a battery life field 702 to store a value indicating the battery status, a GPS enabled field 704 to indicate whether the wireless telephonic device is GPS enabled, a latitude field 706 and a longitude field 708 to store values representative of the present latitude and longitude, respectively, of the wireless telephonic device, and a velocity field 710 to store a value representative of the calculated or approximated velocity of the wireless telephonic device.

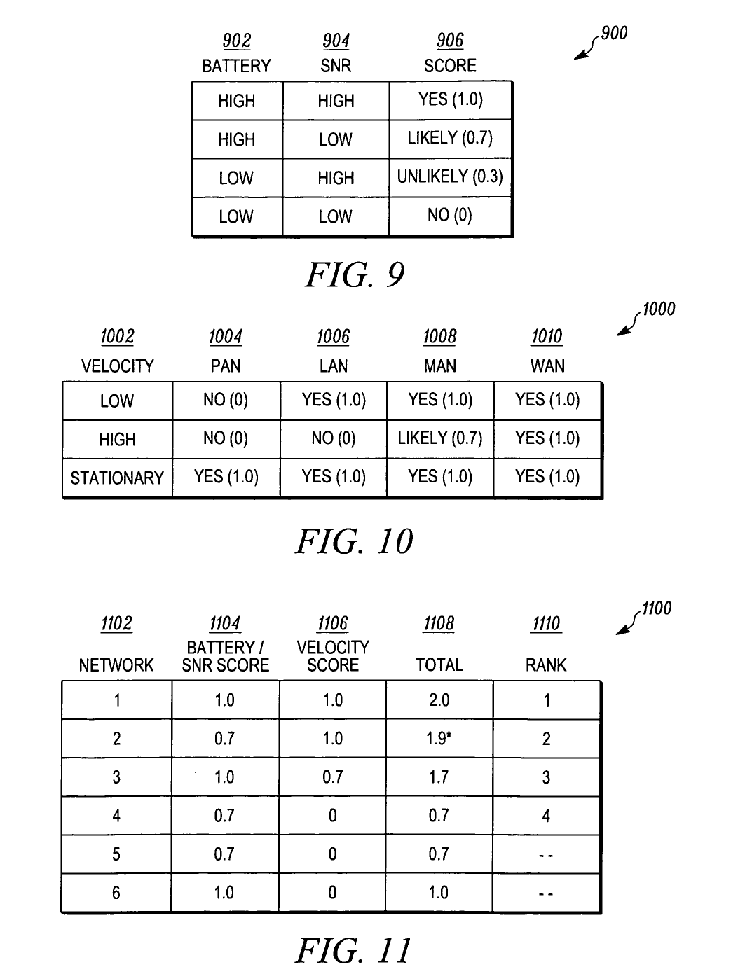

FIGS. 8-11 illustrate a method 800 for determining a relative compatibility of each of a plurality of accessible networks based on a comparison of the characteristics of the accessible networks to the characteristics of a wireless telephonic device (e.g., the wireless telephonic device 102, FIG. 1) in accordance with at least one embodiment of the present disclosure. At block 802, the wireless telephonic device scores each accessible network based on its corresponding SNR and the battery status. To illustrate, the example table 900 of FIG. 9 comprises a plurality of scoring entries, each scoring entry comprising a battery field 902 indicating a relative battery status (e.g., “High” or “Low”), an SNR field 904 indicating a relative SNR (e.g., “High” or “Low”), and a score field 906 indicating a score associated with the corresponding combination of relative battery status and relative SNR. As illustrated, a combination of a “High” battery status and a “High” SNR corresponds to a “Yes” score, which in this example is weighted as a value of 1.0; a combination of a “High” battery status and a “Low” SNR corresponds to a “Likely” score, which in this example is weighted as a value of 0.7; a combination of a “Low” battery status and a “High” SNR corresponds to a “Unlikely” score, which in this example is weighted as a value of 0.3; and a combination of a “Low” battery status and a “Low” SNR corresponds to a “No” score, which in this example is weighted as a value of 0.0. Accordingly, an accessible network determined to have a “High” SNR when the battery power is “High” would be assigned a score of “Yes” or 1.0 at block 802, whereas an accessible network determined to have a “Low” SNR when the battery power is “High” would be assigned a score of “Likely” or 0.7 at block 802.

At block 804, the wireless telephonic device scores each of the accessible networks based on a comparison of each network's velocity characteristics (e.g., coverage range and hand-off efficiency) to the velocity of the wireless telephonic device. To illustrate, the example table 1000 of FIG. 10 comprises a plurality of scoring entries, each scoring entry having a velocity field 1002 representing a relative velocity (or, alternatively, a velocity range) and capability fields 1004, 1006, 1008, and 1010, each representing a score associated with a corresponding relative velocity capability for a PAN network type, a LAN network type, a MAN network type, and a WAN network type, respectively. To illustrate, because PANs typically have very limited coverage area and have relatively poor hand-off capabilities, the PAN network may be scored as “No” for relatively low and high velocities, but may be scored as “Yes” when the velocity indicates the wireless telephonic device is relatively stationary. Conversely, because a WAN network typically has a relatively large coverage area and relatively efficient hand-off capabilities, the WAN network type may be scored as “Yes” for all relative velocities. Thus, based on the depicted table 1000, an accessible network identified as a MAN network would be assigned a score of “Yes” or 1.0 at block 804 if the relative velocity of the wireless telephonic device is relatively low or it would be assigned a score of “Likely” or 0.7 at a block 804 if the relative velocity of the wireless telephonic device is relatively high.

At block 806 the scores determined at blocks 802 and 804 are summed for each network to create a total score for each accessible network. As part of the summing process, the various individual scores may be weighted as appropriate. To illustrate, an accessible network that is also identified as the default network for voice communications by the wireless telephonic device may have its overall score scaled by a certain factor (e.g., scaled by a factor of 1.2). As another example, certain networks may be identified as requiring less power for signal transmissions (e.g., a PAN-compatible transceiver typically consumes less power than a MAN-compatible transceiver). Accordingly, a weighting factor may be applied to the total score or an individual score so as to skew scores upward for relatively low power consumption networks and to skew scores downward for relatively high power consumption networks. Further, in some instances, a certain characteristic may be determined to automatically prevent a network from being used for emergency telephone calling. For example, a network may not be accessible, or a certain network may not provide emergency telephone calling services, thereby discouraging their use for emergency telephone calling.

Table 1100 of FIG. 11 represents an example table generated as a result of the summing of scores at block 806. The table 1100 includes a plurality of entries, each entry associated with a corresponding network and including a network ID field 1102 to identify the network, a battery/SNR score field 1104 indicating the score for the network as determined at block 802, a velocity score field 1106 indicating the score for the network as determined at block 804, a total score field 1108 as determined from the battery/SNR score field 1104, the velocity score field 1106, and any weighting factors at block 806, and a rank score field 1110 indicating a relative ranking of the networks based on the total score in the total score fields 1108. In the depicted example, network 2 is the default voice communications network and accordingly has its original total score of 1.7 weighted by a factor of 1.1 so as to generate a skewed total score of 1.9. Accordingly, network 1 is ranked first due to its total score of 2.0, network 2 is ranked second due to its total score of 1.9, network 3 is ranked third due to its total score of 1.7, and network 4 is ranked fourth due to its total score of 0.7. Further, because network 5 is inaccessible and network 6 does not support emergency telephone calling services in this example, networks 5 and 6 are disqualified.

At block 808, a primary network and one or more secondary networks are selected based on the total scores for the set of identified networks. In at least one embodiment, the total score of a network correlates to its relative compatibility with the characteristics of the wireless telephonic device for the purposes of conducting an emergency telephone call. Accordingly, in this instance, the primary network typically is selected as the network having the highest total score (network 1 in the example of FIG. 11), and secondary networks are selected as the networks having the next highest total scores (network 2 followed by network 3 followed by network 4 in the example of FIG. 11). Emergency telephone calls then can be initiated over the selected primary network and one or more secondary networks as described above.

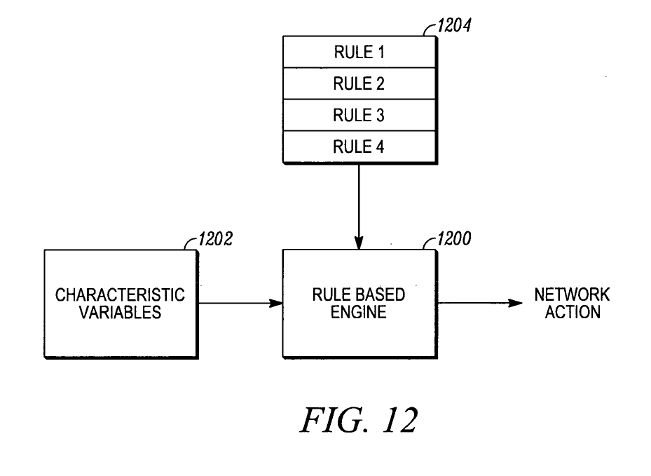

FIG. 12 illustrates an alternate technique for initiating emergency telephone calls via multiple networks using a rules-based engine for comparing the characteristics of the networks and a wireless telephonic device in accordance with at least one embodiment of the present disclosure. In the depicted example, the wireless telephonic device (e.g., wireless telephonic device 102, FIG. 1) implements a rule-based engine 1200 to determine various network actions to implement based on characteristics variables 1202 for the networks and the wireless telephonic device and based on a set of filter rules 1204 to which the characteristics variables 1202 are applied. The rule-based engine 1200 can be implemented as, for example, a LISP-based or official production system 5 (OPS5)-based rules-driven expert system.

In one embodiment, the characteristics variables 1202 are static or dynamic variables related to the operation of the wireless telephonic device, such as, for example, the velocity of the wireless telephonic device, the remaining power available to the wireless telephonic device, and the SNRs of the signals available from the wireless networks. In this implementation, the set of filter rules 1204 includes one or more filter rules for each wireless network that control the operation of the wireless telephonic device with respect to the wireless network. For example, in one embodiment, the set of filter rules 1204 includes, for each wireless network or network type, a filter rule that controls the action of activating the interface to the wireless network, a filter rule that controls the action of deactivating the interface to the wireless network, a filter rule that initiates an emergency telephone call via the activated interface to the wireless network, a filter rule that terminates an initiated emergency telephone call, and the like. To illustrate by way of example, assume that the set of filter rules 1204 includes a filter rule RULE1 (SNR>con1, power level > con 2, velocity<con3) then activate IF1, whereby con1, con2, and con3 represent definable condition and IF1 represents the interface to network 1. Thus, when the characteristic variables SNR, power level, and velocity are determined to meet the provided conditions, the rules-based engine 1200 initiates the corresponding action, namely activating the interface to network 1. Similar filter rules can be implemented to initiate an emergency telephone call over the activated interface, terminate an emergency telephone call over the activated interface, and the like.

Although exemplary scoring-based techniques and expert-system based techniques for selecting a network for conducting an emergency telephone call from a wireless telephonic device based on a compatibility between the network and the wireless telephonic device are discussed herein, other selection techniques, such as fuzzy logic-based selection techniques, may be implemented without departing from the scope of the present disclosure.

What is claimed is:

1. A method comprising:
determining a set of characteristics for each wireless network of a plurality of wireless networks accessible by a wireless telephonic device;
determining a first select wireless network of the plurality of wireless networks based on a comparison of a set of characteristics of the wireless telephonic device to the set of characteristics of each wireless network of the plurality of wireless networks; and
initiating, at the wireless telephonic device, a first telephone call via the first select wireless network.

2. The method of claim 1, wherein the set of characteristics of the wireless telephonic device comprises at least one of: a remaining battery power of the wireless telephonic device, a current location, and a velocity of the wireless telephonic device.

3. The method of claim 1, wherein the set of characteristics of each wireless network comprises at least one of: a signal-to-noise ratio; a power requirement for communicating with the wireless network; emergency calling services support; and a velocity capability of the wireless network.

4. The method of claim 1, wherein determining the first select wireless network of the plurality of wireless networks comprises selecting as the first select wireless network a wireless network of the plurality of wireless networks having a set of characteristics most compatible with the set of characteristics of the wireless telephonic device.

5. The method of claim 1, wherein determining the first select wireless network of the plurality of wireless networks comprises:
determining a score for each wireless network based on a sum of values, each value representative of a degree of compatibility between a characteristic of the wireless network with a corresponding characteristic of the wireless telephonic device; and
selecting as the first select wireless network a wireless network having the highest ranking score.

6. The method of claim 5, further comprising:
weighting a score of a default wireless network for non-emergency calling of the plurality of wireless networks.

7. The method of claim 1, further comprising:
determining a second select wireless network of the plurality of wireless networks; and
initiating, at the wireless telephonic device, a second telephone call via the second select wireless network concurrently with the first telephone call.

8. The method of claim 7, further comprising:
continuing as a connected telephone call a first one of the first telephone call or the second telephone call to establish a connection; and
terminating a second one of the first telephone call or the second telephone call to establish a connection.

9. The method of claim 8, further comprising:
initiating, at the wireless telephonic device, a third telephone call via the first select wireless network and a fourth telephone call via the second select wireless network concurrent with the third telephone call in response to an unintended termination of the connected telephone call.

10. The method of claim 7, wherein:
the first select wireless network comprises a first network type, the first network type comprising one of: a wide area network; a metropolitan area network; a local area network; or a personal area network; and
the second select wireless network comprises a second network type different than the first network type.

11. The method of claim 1, wherein the first telephone call comprises an emergency telephone call.

12. A method comprising:
receiving user input indicating an emergency telephone call is to be made at a wireless telephonic device;
determining a first network of a plurality of wireless networks available to the wireless telephonic device;
determining a second network of the plurality of wireless networks, the second network of a different network type than the first network;
initiating a first emergency telephone call from the wireless telephonic device via each of the first network and the second network; and
disconnecting the second one of the first network or the second network to establish the emergency telephone call.

13. The method of claim 12, further comprising:
reinitiating the emergency telephone call from the wireless telephonic device via at least one of the first network or the second network in response to an unintended termination of the emergency telephone call.

14. The method of claim 12, wherein:
receiving user input indicating an emergency telephone call comprises receiving user input indicating a first character entry of an emergency telephone number;
determining the first network comprises determining the first network in response to receiving the user input indicating a character entry of an emergency telephone number; and
determining the second network comprises determining the second network in response to receiving the user input indicating a character entry of an emergency telephone number.

15. The method of claim 12, wherein determining the first wireless network comprises selecting the first wireless network from a plurality of wireless networks based on a comparison of a set of characteristics of the wireless telephonic device to a set of communication characteristics of each wireless network of the plurality of wireless networks.

16. A device comprising:
a wireless communication interface configured to couple to a plurality of networks;
a processor coupled to the wireless communication interface; and
a memory coupled to the processor, the memory to store a set of executable instructions configured to manipulate the processor to:
determine a set of characteristics for each wireless network of a set of accessible wireless networks;
determine a first select wireless network of the set of accessible wireless networks based on a comparison of a set of characteristics of the device to the set of characteristics for each wireless network of the set of accessible wireless networks; and
initiate a first telephone call via the first select wireless network.

17. The device of claim 16, wherein the instructions configured to manipulate the processor to determine the first select wireless network of the plurality of wireless networks comprise instructions to manipulate the processor to:
score each wireless network based on a sum of values, each value representative of a degree of compatibility between a characteristic of the wireless network with a corresponding characteristic of the device; and
select as the first select wireless network a wireless network having the highest ranking score.

18. The device of claim 16, wherein the set of executable instructions further comprises instructions to manipulate the processor to:
determine a second select wireless network of the set of accessible wireless networks; and
initiate a second telephone call via the second select wireless network concurrently with initiating the first telephone call.

19. The device of claim 16, wherein the first telephone call comprises an emergency telephone call.

20. The device of claim 16, wherein:
the set of characteristics of the device comprises at least one of: a remaining battery power of the device, a current location, and a velocity of the device; and
the set of characteristics of each wireless network comprises at least one of: a signal-to-noise ratio; a power requirement for communicating with the wireless network; emergency calling services support; and a velocity capability of the wireless network.
